(19) United States
(12) Patent Application Publication
(10) Pub. No.: US 2006/0021434 A1
(43) Pub. Date: Feb. 2, 2006

(54) Electronic device and angular velocity detector

(75) Inventor: Yuji Kutsuna, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/190,951

(22) Filed: Jul. 28, 2005

(30) Foreign Application Priority Data
Jul. 29, 2004 (JP) 2004-221077

(51) Int. Cl. G01P 15/08

(52) U.S. Cl. 73/514.12

(57) ABSTRACT

An electronic device includes a plurality of bonding wires through which first and second members are electrically connected, and at least adjacent two of the bonding wires have different wire shapes. For example, an angular velocity detector can be used as the electronic device. In this case, an angular velocity detecting element as the first member is electrically connected to a circuit substrate as the second member using the bonding wires, for example. Because at least adjacent two of the bonding wires have different wire shapes, parasitic capacitance between the bonding wires can be reduced without increasing the distance between adjacent bonding wires.

### CROSS REFERENCE TO RELATED APPLICATION

This application is based on Japanese Patent Application No. 2004-221077 filed on Jul. 29, 2004, the contents of which are incorporated herein by reference in its entirety.

### FIELD OF THE INVENTION

The present invention relates to an electronic device in which a first member and a second member are electrically connected through plural bonding wires. More particularly, the present invention relates to an angular velocity detector in which an angular velocity detecting element and a circuit substrate are electrically connected by using plural bonding wires.

### BACKGROUND OF THE INVENTION

An angular velocity detector used as an electronic device is described in U.S. Pat. No. 6,593,663 (corresponding to JP-A-2003-21647). In this angular velocity detector, an angular velocity detecting element as a first member and a circuit substrate as a second member are electrically connected through plural bonding wires.

For example, an angular velocity detector shown in FIG. 4 includes an angular velocity detecting element 100, a circuit substrate 200, and a package 300 for accommodating the angular velocity detecting element 100 and the circuit substrate 200. The angular velocity detecting element 100 has a substrate 10, and a vibrating body vibratable on a surface parallel to the substrate 10. The angular velocity detecting element 100 detects an angular velocity around an axis perpendicular to the substrate 10 based on a vibration of the vibrating body.

The angular velocity detecting element 100 is stacked on the circuit substrate 200, and is fixed to the circuit substrate 200 using an adhesive. Furthermore, the angular velocity detecting element 100 and the circuit substrate 200 are electrically connected using bonding wires 70, and the circuit substrate 200 and the package 300 are also electrically connected using bonding wires 70. In this connection structure, adjacent bonding wires 70 between the angular velocity detecting element 100 and the circuit substrate 200 are connected approximately in parallel. Accordingly, a high AC voltage (i.e., driving signal) for driving the angular velocity detecting element 100 and a micro-detection signal from the angular velocity detecting element 100 are interfered from each other by parasitic capacitance between the bonding wires 70. Accordingly, the angular velocity detector may be not normally operated, or a detection accuracy of the angular velocity detector may be deteriorated due to noise.

If the parasitic capacitance is made small by enlarging the distance between adjacent bonding wires 70, the size of the angular velocity detector is increased.

### SUMMARY OF THE INVENTION

In view of the above problem, it is an object of the present invention to provide an electronic device having first and second members electrically connected through bonding wires, which can reduce parasitic capacitance between the bonding wires without increasing a distance between the bonding wires.

It is another object of the present invention to reduce parasitic capacitance between bonding wires without increasing a distance between the bonding wires, in an angular velocity detector in which an angular velocity detecting element and a circuit substrate are electrically connected through the bonding wires.

According to the present invention, an electronic device includes first and second members, and a plurality of bonding wires through which the first and second members are electrically connected. In the electronic device, at least adjacent two of the bonding wires have different wire shapes. Therefore, parasitic capacitance between the bonding wires can be reduced without increasing a distance between the bonding wires.

Each of the bonding wires can be electrically connected to the first and second members by a primary bonding and a secondary bonding, and the adjacent bonding wires have reverse bonding order between the primary bonding and the secondary bonding, relative to the first member and the second member.

For example, each of the adjacent bonding wires is bent to have a crest or a trough between the first and second members, and the adjacent bonding wires have different crests or troughs. Therefore, the shapes of the bonding wires can be easily changed. For example, the first and second members have bonding pads on which the bonding wires are electrically bonded, and a distance between the bonding pads of the first member and the second member is approximately the same for the adjacent bonding wires.

When at least the adjacent bonding wires have different wire lengths, or when at least the adjacent bonding wires are bent to have different wire heights, the parasitic capacitance between the bonding wires can be effectively reduced.

As an example, an angular velocity detector can be used as the electronic device. An angular velocity detecting element of the angular velocity detector includes a base substrate, and a vibrating body arranged in the base substrate to be vibrated on a surface horizontal with respect to the base substrate. Here, the angular velocity detecting element detects an angular velocity around an axis perpendicular to the base substrate based on a vibration of the vibrating body.

The angular velocity detecting element as the first member and the circuit substrate as the second member are electrically connected through the bonding wires. Even in this case, the parasitic capacitance between the bonding wires can be effectively reduced without increasing a distance between the bonding wires.

### BRIEF DESCRIPTION OF THE DRAWINGS

The above and other objects, features and advantages of the present invention will become more apparent from the following detailed description of preferred embodiments made with reference to the accompanying drawings, in which:

FIG. 1 is a schematic sectional view showing an angular velocity detector (oscillatory angular rate detector) according to a preferred embodiment of the present invention;

FIG. 2 is a schematic plan view showing the angular velocity detecting element in the angular velocity detector in FIG. 1;

FIG. 3 is a schematic sectional view showing an angular velocity detector according to a modification of the preferred embodiment; and

FIG. 4 is a schematic sectional view showing an angular velocity detector in a related art.

### DETAILED DESCRIPTION OF PREFERRED EMBODIMENT

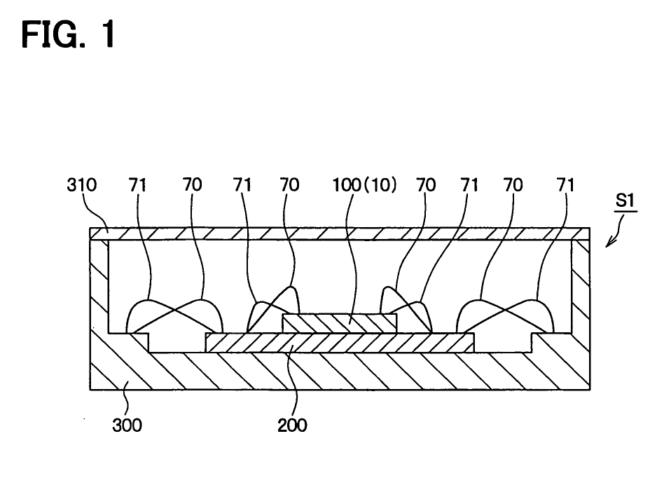

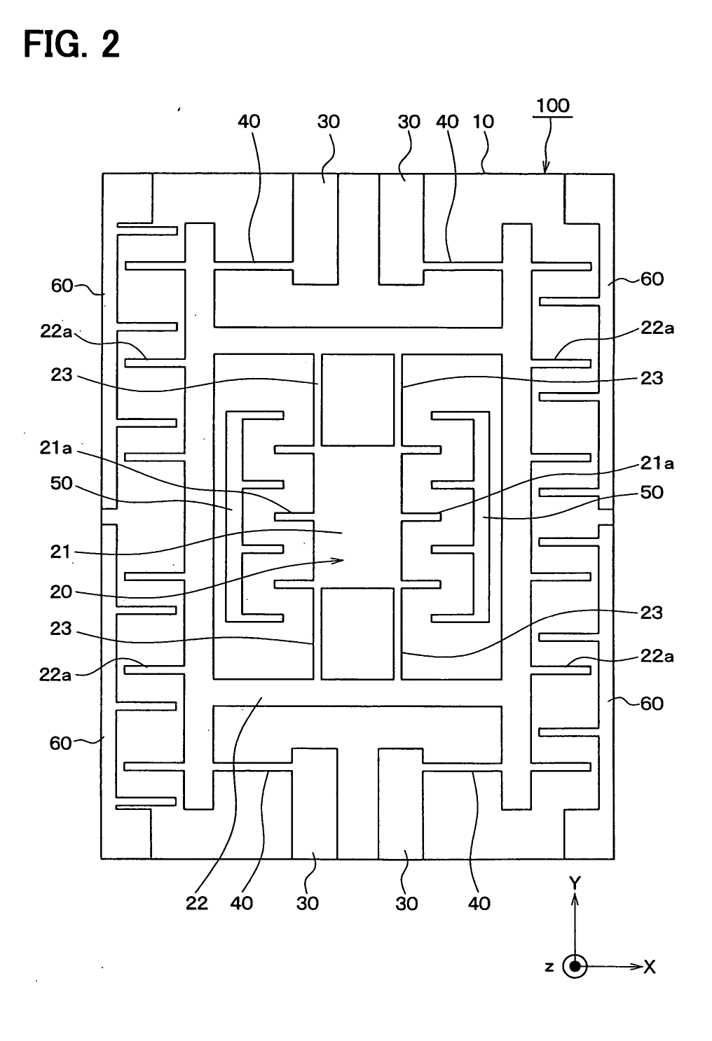

A preferred embodiment of the present invention will be now described with reference to FIGS. 1 and 2. In this embodiment, an angular velocity detector S1 (oscillatory angular rate detector) is typically used as an electronic device in which first and second members are electrically connected through plural bonding wires.

As shown in FIG. 1, an angular velocity detector S1 of this embodiment includes an angular velocity detecting element 100 as the first member, a circuit substrate 200 as the second member, and a package 300 for accommodating the angular velocity detecting element 100 and the circuit substrate 200. The circuit substrate 200 is fixed to the package 300. The angular velocity detector S1 is constructed as a structural body in which the angular velocity detecting element 100 is laminated on the circuit substrate 200 through an adhesive.

First, the angular velocity detecting element 100 will be described with reference to FIG. 2. The angular velocity detecting element 100 has a substrate 10 (base substrate) such as a semiconductor substrate, etc., and is formed by performing well-known micro machine processing with respect to this substrate 10.

For example, a rectangular SOI (silicon-on-insulator) substrate can be used as the substrate 10. The rectangular SOI can be formed by sticking a second silicon layer as a second semiconductor layer through an oxide film as an insulating layer on a first silicon layer as a first semiconductor layer.

As shown in FIG. 2, beam structural bodies 20 to 60 partitioned by grooves are formed by performing trench etching, release etching, etc. with respect to a surface layer of this substrate 10, e.g., the second silicon layer in the SOI substrate.

These beam structural bodies 20 to 60 are constructed with a vibrating body 20, respective beam portions 23, 40 and respective electrodes 50, 60.

The vibrating body 20 is formed in a central portion of the substrate 10 so as to be vibrated on a surface horizontal with respect to the substrate 10, i.e., on the paper surface within FIG. 2. In this example, the vibrating body 20 is constructed with a first vibrating portion 21 located in the central portion and approximately formed in a rectangular shape, a second vibrating portion 22 of a rectangular frame shape located at an outer circumference of this first vibrating portion 21, and a driving beam portion 23 for connecting these first and second vibrating portions 21, 22.

This vibrating body 20 is connected to an anchor portion 30 arranged at a peripheral portion of the substrate 10, through a detecting beam portion 40. Here, the anchor portion 30 is fixed and supported by a lower portion of the surface layer forming the vibrating body 20 in the substrate 10, i.e., by a support substrate portion. The vibrating body 20 is floated from this support substrate portion.

As shown in FIG. 2, the driving beam portion 23 can be elastically deformed substantially in only the x-direction by forming this driving beam portion 23 in a shape extending in e.g., the y-direction. The detecting beam portion 40 can be elastically deformed substantially in only the y-direction by forming this detecting beam portion 40 in a shape extending in e.g., the x-direction.

A first vibrating body portion in the vibrating body 20 can be vibrated by the driving beam portion 23 in the x-direction (drive vibrating direction) on the surface horizontal with respect to the substrate 10. In contrast to this, the entire vibrating body 20 can be vibrated by the detecting beam portion 40 in the y-direction (detection vibrating direction) on the surface horizontal with respect to the substrate 10.

A driving electrode 50 for operating and vibrating the first vibrating portion 21 in the x-direction is arranged between the first vibrating portion 21 and the second vibrating portion 22. Similar to the anchor portion 30, the driving electrode 50 is fixed to the support substrate portion. The driving electrode 50 is arranged so as to be opposed to a comb teeth portion (comb teeth portion for driving) 21a projected from the first vibrating portion 21 such that the mutual comb teeth are engaged with each other.

A detecting electrode 60 is arranged in the outer circumference of the second vibrating portion 22. The detecting electrode 60 is arranged to detect an angular velocity around the z-axis perpendicular to the substrate 10 on the basis of the vibration of the vibrating body 20. Similar to the anchor portion 30, the detecting electrode 60 is fixed to the support substrate portion. The detecting electrode 60 is arranged so as to be opposed to a comb teeth portion (comb teeth portion for detection) 22a projected from the second vibrating portion 22 such that the mutual comb teeth are engaged with each other.

In the angular velocity detecting element 100, pads (not shown) for applying voltages to the vibrating body 20, the driving electrode 50, the detecting electrode 60, etc., and for taking-out signals are arranged as suitable portions of the upper surface of the substrate 10.

In this embodiment, for example, the pads are arranged in a peripheral portion of the substrate 10. Bonding wires 70, 71 made of Au (gold), Al (aluminum), etc., are connected to the pads.

Thus, the upper surface of the substrate 10 of the angular velocity detecting element 100 and the circuit substrate 200 are electrically connected by the bonding wires 70, 71. The bonding wires 70 can be formed by a normal wire bonding technique.

In this circuit substrate 200, for example, a MOS transistor, a bipolar transistor, etc., are formed by using a well-known semiconductor process with respect to a silicon substrate, etc. The circuit substrate 200 can be set to have a function for sending a high voltage AC signal (driving signal) for driving the vibrating body 20 to the angular velocity detecting element 100 and for processing a micro detecting signal from the angular velocity detecting element 100 and externally outputting this signal.

As shown in FIG. 1, this circuit substrate 200 is fixed to the package 300 through an adhesive material.

Here, the package 300 has unillustrated wirings in the interior or the surface, etc. The circuit substrate 200 and the wirings of the package 300 are electrically connected by the bonding wires 70, 71. The output signal from the circuit substrate 200 is sent to the exterior from the wirings of the package 300 through the bonding wires 70, 71.

For example, this package 300 can be formed of a laminating substrate in which plural ceramic layers of alumina, etc., are laminated. In the laminating substrate, the wirings of the package 300 are formed between the respective layers, and each wiring is electrically conducted by a through hole, etc. As shown in FIG. 1, a cover 310 is attached to an opening portion of the package 300, and the cover 310 seals the interior of the package 300.

As shown in FIG. 1, a part of the plural bonding wires 70, 71, for electrically connecting the angular velocity detecting element 100 and the circuit substrate 200 and for electrically connecting the circuit substrate 200 and the package 300, has a shape different from the other part thereof.

In the example shown in FIG. 1, the bonding order between a primary bonding and a second bonding of adjacent bonding wires 70 and 71 is set reversely relative to the angular velocity detecting element 100 and the circuit substrate 200 when the first member is the angular velocity detecting element 100 and the second member is the circuit substrate 200.

Similarly, in the example of FIG. 1, the bonding order between the primary bonding and the secondary bonding of the adjacent bonding wires 70 and 71 is set reversely relative to the circuit substrate 200 and the package 300 when the first member is the circuit substrate 200 and the second member is the package 300.

Accordingly, the bonding wires 70, 71 have different shapes due to the reverse bonding order between the primary bonding and the secondary bonding. The wire shapes of the bonding wires 70, 71 can be changed by changing a loop height or a loop shape of the bonding wires 70, 71. Furthermore, all wire shapes of the plural bonding wires 70, 71 can be set different from each other.

In this embodiment, the signals flowing the bonding wires 70, 71 are high-voltage AC signals (driving signals) for driving the angular velocity detecting element 100 and micro-detection signals from the angular velocity detecting element 100. Therefore, it is better for the micro-detection signals to be not interfered from the micro-detection signals as much as possible.

For example, the wire shape of the bonding wire 70, in which the driving signal flows, can be set different from the wire shape of the bonding wire 71 in which the detection signal flows.

In an angular velocity detector S1 of this embodiment, the circuit substrate 200 is fixed to the package 300 through an adhesive, and the angular velocity detecting element 100 is fixed to the circuit substrate 200 through an adhesive. Thereafter, the wire bonding is performed, and the cover 310 is attached, so that the angular velocity detector S1 can be manufactured.

In the angular velocity detector S1, a driving signal (sine wave voltage, etc.) is applied from the circuit substrate 200 to the driving electrode 50 through the bonding wire 70, and electrostatic force is generated between the comb teeth portion 21a of the above first vibrating portion 21 and the driving electrode 50. Thus, the first vibrating portion 21 is driven and vibrated in the x-direction by the elastic force of the driving beam portion 23.

When an angular velocity Ω is applied around the z-axis on the basis of the driving vibration of this first vibrating portion 21, Coriolis force is applied to the first vibrating portion 21 in the y-direction, and the entire vibrating body 20 is vibrated in the y-direction by the elastic force of the detecting beam portion 40.

The capacity between the detecting electrode 60 and the comb teeth of the comb teeth portion 22a for detection is changed by this vibration in the y-direction. Therefore, the magnitude of the angular velocity Ω can be calculated by detecting this capacity change.

For example, when the vibrating body 20 is displaced in one direction along the y-axis direction in FIG. 2, the detecting electrode 60 of the left side and the detecting electrode 60 of the right side in the left and right detecting electrodes 60 in FIG. 2 are set to be reverse to each other in the capacity change. Therefore, the angular velocity is calculated by converting the respective capacity changes in the left and right detecting electrodes 60 into voltages and by differentiating, amplifying and outputting both the voltage values.

In accordance with this embodiment, the angular velocity detector S1 can be used as an electronic device. In this case, the electronic device includes a first member (e.g., an angular velocity detecting element) 100 and a second member (e.g., circuit substrate) 200 which are electrically connected to each other through plural bonding wires 70, 71. Furthermore, the plural bonding wires 70, 71 are formed such that at least the wire shape of a part of the plural bonding wires 70, 71 is different to the wire shape the other part of the plural bonding wires 70, 71. For example, the wire shapes of at least adjacent two of the plural bonding wires 70, 71 can be formed to be different from each other, or the wire shapes of all the plural bonding wires 70, 71 can be formed to be different from each other. Accordingly, even when the distance between adjacent bonding wires 70, 71 having different shapes is not made larger, a facing area between the adjacent bonding wires 70, 71 can be made smaller, and the parasitic capacitance between those bonding wires 70, 71 can be effectively reduced.

For example, the wire shapes of the adjacent bonding wires 70 and 71, in which different signals that are not preferable when interfering with each other flow, are set to be different from each other. Therefore, signal interference due to the parasitic capacitance can be effectively reduced, and it can restrict the operation or accuracy of the angular velocity detector 100 from being deteriorated. Accordingly, the angular velocity detector S1 can effectively reduce the parasitic capacitance between the bonding wires 70, 71 even when the distance between the bonding wires 70, 71 is set smaller.

In the angular velocity detector S1, the bonding order of the primary bonding and the secondary bonding of the bonding wires 70, 71 is performed reversely relative to the angular velocity detecting element 100 (first member) and the circuit substrate 200 (second member).

Specifically, in a case where a bonding wire 70 has a rapidly standing portion at the side of the angular velocity detecting element 100 and a gradually declined portion at the side of the circuit substrate 200, this bonding wire 70 performs the first bonding at the side of the angular velocity detecting element 100 and performs the second bonding at the side of the circuit substrate 200. In contrast, a bonding wire 71 has a gradually standing portion at the side of the angular velocity detecting element 100 and a quickly declined portion at the side of the circuit substrate 200. In this case, this bonding wire 71 performs the first bonding at the side of the circuit substrate 200 and performs the second bonding at the side of the velocity detecting element 100. Accordingly, the wire shapes of adjacent bonding wires 70 and 71 can be made different from each other.

Each of the bonding wires 70, 71 is bent to have a crest or a trough. In this embodiment, adjacent bonding wires 70 and 71 have shifted crests or troughs while the distance between the bonding pads of the first and second members is approximately equal. Therefore, the shapes of the adjacent bonding wires 70 and 71 are different from each other.

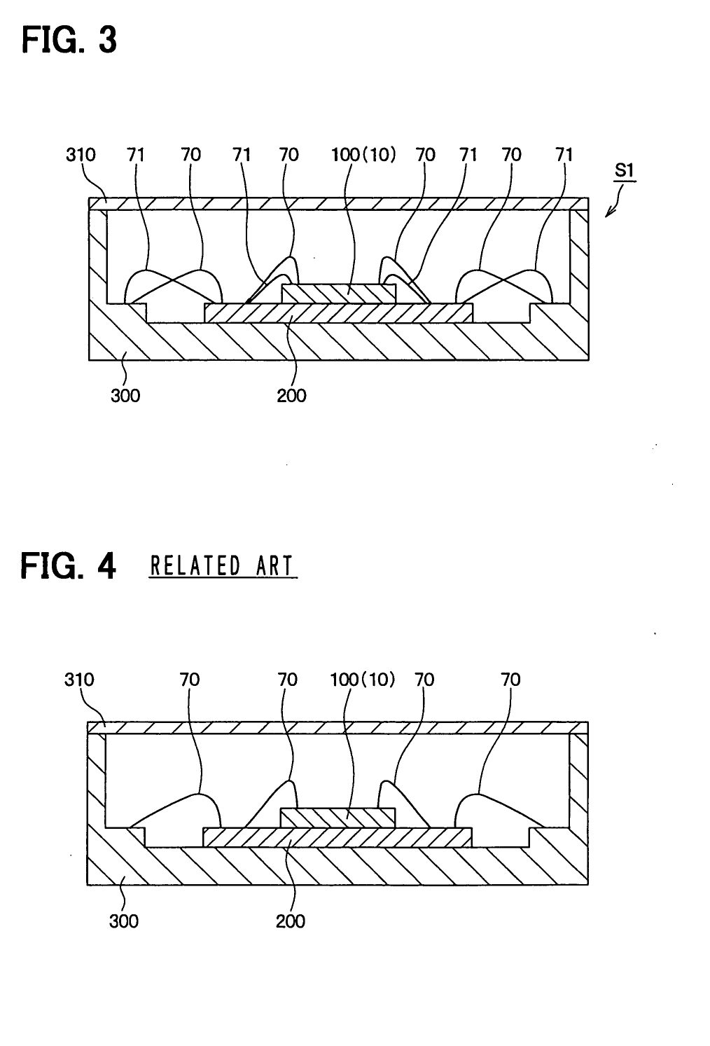

Alternatively, the loop heights, loop shapes, or loop lengths of the bonding wires 70, 71 can be changed so that the wire shapes of the bonding wires 70, 71 are changed. For example, as shown in FIG. 3, adjacent two bonding wires 70, 71 between the angular velocity detecting element 100 and the circuit substrate 200 have different loop lengths so that the crest heights (trough heights) of the adjacent bonding wires 70 are made different from each other. Even in this case, the distance between the bonding pads of the angular velocity detecting element 100 and the circuit substrate 200 can be set approximately equal.

### Other Embodiments

Although the present invention has been described in connection with the preferred embodiment thereof with reference to the accompanying drawings, it is to be noted that various changes and modifications will become apparent to those skilled in the art.

For example, it is sufficient for the angular velocity detecting element 100 to have the substrate 10 and the vibrating body 20 arranged in the substrate 10 and able to be vibrated on the surface horizontal with respect to the substrate, and detect the angular velocity around the axis perpendicular to the substrate 10 on the basis of the vibration of the vibrating body 20. No angular velocity detecting element is limited to the angular velocity detecting element 100 as shown in the above embodiment.

Further, the angular velocity detector may be also set to a detector having no package 300 mentioned above. That is, it is not necessary that the laminating body provided by laminating the angular velocity detecting element 100 and the circuit substrate 200 is accommodated in the package 300. For example, in an angular velocity detector, this laminating body may be mounted to a printed-wiring board, a ceramic wiring board, etc., and electric connection using the wire bonding, etc. may be performed.

Further, in the above-described embodiment, the angular velocity detecting element 100 is used as a sensor element (first member) stacked on the circuit substrate 200 (second member). However, as the sensor element laminated on the circuit substrate 200, an acceleration detecting element, a pressure detecting element, a temperature detecting element, a humidity detecting element, a light detecting element, etc. can be used.

Furthermore, the first member connected to the bonding wires 70, 71 in the electronic device is not limited to the sensor element, and the second member connected to the bonding wires 70, 71 in the electronic device is not limited to the circuit substrate. For example, the circuit substrate 200 can be used as the first member of the electronic device, and the package 300 can be used as the second member of the electronic device.

The present invention can be suitably applied to an electronic device having first and second members electrically connected by bonding wires.

While the invention has been described with reference to preferred embodiments thereof, it is to be understood that the invention is not limited to the preferred embodiments and constructions. The invention is intended to cover various modification and equivalent arrangements. In addition, while the various elements of the preferred embodiments are shown in various combinations and configurations, which are exemplary, other combinations and configuration, including more, less or only a single element, are also within the spirit and scope of the invention.

What is claimed is:

1. An electronic device comprising:
first and second members; and
a plurality of bonding wires through which the first and second members are electrically connected,
wherein at least adjacent two of the bonding wires have different wire shapes.

2. The electronic device according to claim 1, wherein:
each of the bonding wires is electrically connected to the first and second members by a primary bonding and a secondary bonding; and
the adjacent bonding wires have reverse bonding order between the primary bonding and the secondary bonding, relative to the first member and the second member.

3. The electronic device according to claim 1, wherein:
each of the adjacent bonding wires is bent to have a crest or a trough between the first and second members; and
the adjacent bonding wires have different crests or troughs.

4. The electronic device according to claim 3, wherein:
the first and second members have bonding pads on which the bonding wires are electrically bonded; and
a distance between the bonding pads of the first member and the second member is approximately the same for the adjacent bonding wires.

5. The electronic device according to claim 1, wherein the adjacent bonding wires have different wire lengths.

6. The electronic device according to claim 1, wherein the adjacent bonding wires are bent to have different wire heights.

7. An angular velocity detector comprising:
an angular velocity detecting element including a base substrate, and a vibrating body arranged in the base substrate to be vibrated on a surface horizontal with respect to the base substrate, wherein the angular velocity detecting element detects an angular velocity around an axis perpendicular to the base substrate based on a vibration of the vibrating body;
a circuit substrate electrically connected to the angular velocity detecting element; and
a plurality of bonding wires through which the angular velocity detecting element is electrically connected to the circuit substrate,
wherein at least adjacent two of the bonding wires have different wire shapes.

8. The angular velocity detector according to claim 7, wherein:
each of the bonding wires is electrically connected to the first and second members by a primary bonding and a secondary bonding; and
the adjacent bonding wires have reverse bonding order between the primary bonding and the secondary bonding, relative to the first member and the second member.

9. The angular velocity detector according to claim 7, wherein:
the angular velocity detecting element is bonded to the circuit substrate through an adhesive; and
a top surface of the base substrate of the angular velocity detecting element and the circuit substrate are electrically connected through the bonding wires.

10. The angular velocity detector according to claim 7, wherein:
each of the adjacent bonding wires is bent to have a crest or a trough between the angular velocity detecting element and the circuit substrate; and
the adjacent bonding wires have different crests or troughs.

11. The angular velocity detector according to claim 7, wherein the adjacent bonding wires have different wire lengths.

12. The angular velocity detector according to claim 7, wherein the adjacent bonding wires are bent to have different wire heights.
